(19) United States
(12) Patent Application Publication
(10) Pub. No.: US 2021/0072936 A1
(43) Pub. Date: Mar. 11, 2021

(54) INPUT DEVICE, IMAGE FORMING DEVICE, INPUT DEVICE CONTROL METHOD, AND RECORDING MEDIUM

(71) Applicant: Konica Minolta, Inc., Tokyo (JP)

(72) Inventor: Hisataka Funakawa, Tokyo (JP)

(73) Assignee: Konica Minolta, Inc., Tokyo (JP)

(21) Appl. No.: 17/018,278

(22) Filed: Sep. 11, 2020

(30) Foreign Application Priority Data
Sep. 11, 2019 (JP) 2019-165255

(51) Int. Cl. G06F 3/12; G06F 3/01; G06F 3/0488; G06F 3/0481; G06F 3/0482; G06F 3/044; G06F 3/042

(52) U.S. Cl. CPC G06F 3/1253; G06F 3/016; G06F 3/04883; G06F 3/042; G06F 3/0482; G06F 3/044; G06F 3/04812

(57) ABSTRACT

An input device includes: a display having a display area; a touch panel having an operation surface that overlaps the display area; a vibrator that generates a vibration causing the operation surface to vibrate; and a hardware processor. The hardware processor that detects, as an input operation, approach of a pointer within a detection distance from the operation surface and touch of the pointer on the operation surface; causes the vibrator to generate the vibration based on the input operation; and adjusts the detection distance to cause the vibrator to start generating the vibration before the input operation ends.

### CROSS-REFERENCE TO RELATED APPLICATIONS

The entire disclosure of Japanese Patent Application No. 2019-165255 filed on Sep. 11, 2019 is incorporated herein by reference.

### BACKGROUND

### Technical Field

The present invention relates to an input device, an image forming device, an input device control method, and a recording medium.

### Description of the Related Art

There have been input devices that detect touch of an operating means such as a finger on an operation panel and receives input operations. Such input devices are used not only in mobile devices such as smartphones and tablet terminals but also in stationary devices such as image forming devices (printers, multifunctional peripherals, etc.). There has been a technique of sending a notification to the user via vibration (vibration response) in response to a received input operation (ex. JP 2014-078050 A).

In application of the above-referenced technique of vibration response to a mobile device, it suffices just to transmit vibration to the hand holding the mobile device, and only a part (ex. the back surface which is usually in contact with the hand) of the mobile device is designed to vibrate in response to an input operation.

However, in its application to a stationary device such as an image forming device, vibration can be transmitted to the user via an operating means in contact with the operation panel only. Thus, the operation surface is designed to vibrate when the operating means touches the operation surface.

However, the operating means is in contact with the operation panel only for a short time, usually about 100 msec. Therefore, in the case where the processing capacity is low or other processing is in operation in parallel with the input operation, sometimes it is impossible to start vibration while the operating means is in contact with the operation surface, as it takes time to perform various kinds of processing for vibration of the operation surface.

As described above, it is not easy to reliably effectuate vibration responses in the above-referenced technique.

### SUMMARY

One or more embodiments of the present invention provide an input device, an image forming device, an input device control method, and a recording medium that can effectuate vibration responses more reliably.

According to one or more embodiments, an input device includes:

a display;

a touch panel including an operation surface that overlaps a display area of the display;

a vibrator that performs a vibration action to cause the operation surface to vibrate; and

a hardware processor,

wherein the hardware processor:
detects, as an input operation, approach of an operating means (i.e., a pointer) within a detection distance to the operation surface and touch of the operating means on the operation surface;
causes the vibrator to perform the vibration action according to the input operation detected by the hardware processor; and
adjusts the detection distance so that the vibrator starts the vibration action before the input operation ends.

According to one or more embodiments, an image forming device includes:

the input device; and

an image forming section (image former) that forms an image on a recording medium based on the input operation detected by the input device.

A control method of an input device according to one or more embodiments, wherein the input device includes:
a display;
a touch panel including an operation surface that overlaps with a display area of the display; and
a vibrator that performs a vibration action to cause the operation surface to vibrate, and

wherein the method includes:
detecting, as an input operation, approach of an operating means within a detection distance to the operation surface and touch of the operating means on the operation surface;
causing the vibrator to perform the vibration action according to the input operation detected by the hardware processor; and
adjusting the detection distance so that the vibrator starts the vibration action before the input operation ends.

A computer-readable recording medium storing instructions for an input device according to one or more embodiments, wherein the input device includes:
a display;
a touch panel including an operation surface that overlaps with a display area of the display; and
a vibrator that performs a vibration action to cause the operation surface to vibrate, and

wherein the instructions cause a computer of the input device to:
detect, as an input operation, approach of an operating means within a detection distance to the operation surface and touch of the operating means on the operation surface;
cause the vibrator to perform the vibration action according to the input operation detected by the hardware processor; and
adjust the detection distance so that the vibrator starts the vibration action before the input operation ends.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are no intended as a definition of the limits of the present invention, wherein:

FIG. 1 shows a schematic configuration of an image forming device;

FIG. 2 shows a configuration of an image forming section;

FIG. 3 is a cross-sectional view showing a configuration of an operation/display interface;

FIG. 4 shows an example of an operation screen displayed on the display;

FIG. 5 is a cross-sectional view showing a configuration of a touch panel;

FIG. 6 is an explanatory diagram showing a method of detecting approach of a finger by the touch panel;

FIG. 7 is a block diagram showing a main functional configuration of the image forming device;

FIG. 8 is an explanatory diagram showing actions of a vibration response and vibration response time;

FIG. 9 is an explanatory diagram showing actions of a vibration response after adjustment of detection distances;

FIG. 10 is a flow chart showing control steps of a detection distance adjustment process;

FIG. 11 is a flow chart showing control steps of a vibration response time specification process;

FIG. 12 is a flow chart showing control steps of an input operation reception process;

FIG. 13 is a flow chart showing control steps of an input operation reception process in Variation 1; and

FIG. 14 is a cross-sectional view showing a configuration of a touch panel in Variation 3.

### DETAILED DESCRIPTION

Hereinafter, embodiments of an input device, an image forming device, an input device control method, and a recording medium are described.

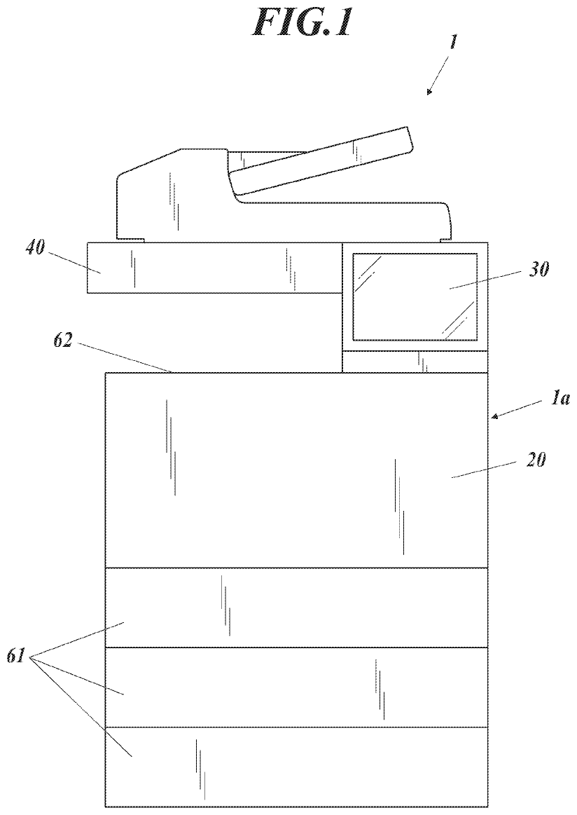

FIG. 1 shows a schematic configuration of the image forming device 1 in one or more embodiments of the present invention.

The image forming device 1 in one or more embodiments is an MFP that forms color images by the electrophotographic method.

As shown in FIG. 1, the image forming device 1 includes a housing 1a, an image forming section 20, an operation/display interface 30, a scanner 40, a sheet feeding tray 61, and a sheet ejection tray 62.

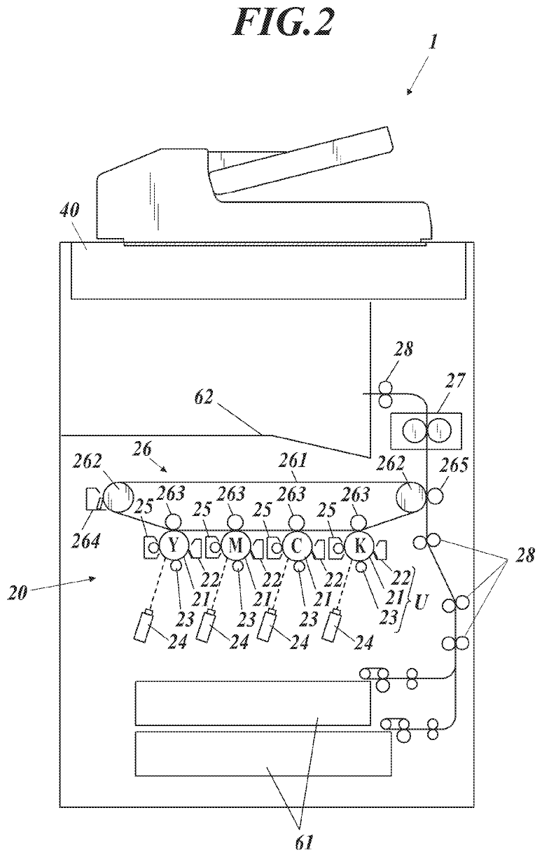

FIG. 2 shows a configuration of the image forming section 20.

The image forming section 20, which is disposed inside the housing 1a, forms an image on a sheet (recording medium) supplied from the sheet feeding tray 61 and ejects it to the sheet ejection tray 62.

The image forming section 20 includes a drum-shaped photoceptor that holds an electrostatic latent image on the surface as an image carrier 21, a cleaning unit 22 that removes remaining toner on the surface of the image carrier, a charging roller 23 that uniformly charges the surface of the image carrier 21, an exposure unit 24 that forms an electrostatic latent image by exposing the charged surface of the image carrier 21, a developing unit 25 that forms a toner image on the surface of the image carrier 21 by developing the electrostatic latent image with a developer including toner, a transfer unit 26 that primarily transfers the formed toner image onto an intermediate transfer belt 261 in a transfer area and secondarily transfers it onto a sheet from the intermediate transfer belt 261, a fixing unit 27 that fixes the toner image on the sheet, and conveying rollers 28 that convey the sheet on the conveyance path from the sheet feeding tray 61 to the sheet ejection tray 62. An image generating unit is formed by the image carrier 21, the cleaning unit 22, the charging roller 23, the exposure unit 24, and the developing unit 25 among the above-described components.

Four image generating units are formed respectively corresponding to colors of yellow (Y), magenta (M), cyan (C), and black (K) and arranged in the order of Y, M, C, K along the lower horizontal surface of the intermediate transfer belt 261. In each of the image generating units, the cleaning unit 22, the charging roller 23, the exposure unit 24, and the developing unit 25 are arranged in that order along the outer peripheral surface of the image carrier 21.

The image carrier 21 rotates around a predetermined rotation axis. A photosensitive layer is formed on the outer peripheral surface of the image carrier 21.

The cleaning unit 22, which includes a plate-shaped cleaning blade made of an elastic body, removes foreign matters such as remaining toner that is attached on the surface of the image carrier 21 and not transferred onto the intermediate transfer belt 261 as the cleaning blade abuts the surface of the image carrier 21.

The charging roller 23 is a cylindrical member that abuts the surface of the image carrier 21 and is driven to rotate around a predetermined rotation axis with rotation of the image carrier 21. The charging roller 23 uniformly charges the surface of the image carrier 21 as a charge driving voltage is applied by a power unit not shown in the drawings.

The exposure unit 24, which includes a laser diode (LD) as a light emitting element, irradiates the surface of the image carrier 21 charged by the charging roller 23 with a laser beam for exposure and forms an electrostatic latent image on the image carrier 21.

The developing unit 25 includes a developing sleeve (developing roller) arranged facing the surface of the image carrier 21. The developing unit 25 supplies developer including toner supplied from a toner bottle not shown in the drawings to the surface of the developing sleeve to which a predetermined developing bias potential is applied, and thereby the toner in the developer is attached onto the electrostatic latent image on the surface of the image carrier 21 from the surface of the developing sleeve to form the toner image on the surface of the image carrier 21.

The transfer unit 26 includes two belt conveyance rollers 262, four primary transfer rollers 263 arranged respectively facing the image carriers 21, an intermediate transfer belt 261 that extends around the belt conveyance roller 262 and the primary transfer roller 263, a belt cleaning unit 264 that removes the toner remaining on the intermediate transfer belt 261, and a secondary transfer roller 265 that is driven, while being attached to one belt conveyance roller 262, to rotate by rotation of the belt conveyance roller 262.

In the transfer unit 26, as the intermediate transfer belt 261 circulates in a state where a bias voltage that has reverse polarity than that of the toner is applied to the primary transfer roller 263, the toner is transferred onto the intermediate transfer belt 261 from the surface of the rotating image carrier 21. After the toners of colors of Y, M, C, and K are transferred to be overlaid on one another, the sheet passes between the secondary transfer roller 265 and the intermediate transfer belt 261 to which the predetermined bias voltages are applied, and thereby the colored toner image is transferred onto the sheet from the intermediate transfer belt 261. The toner that is not transferred onto the sheet and remaining on the intermediate transfer belt 261 is removed by the cleaning blade of the belt cleaning unit 264.

The fixing unit 27 heats the sheet onto which the toner image is transferred and applies a voltage thereto to fix the toner image on the sheet. The fixing unit 27 includes a pair of rollers of a heating roller and a pressure roller that hold the sheet in between. The sheet on which the toner image is fixed is conveyed by the conveying rollers 28 and sent to the sheet ejection tray 62.

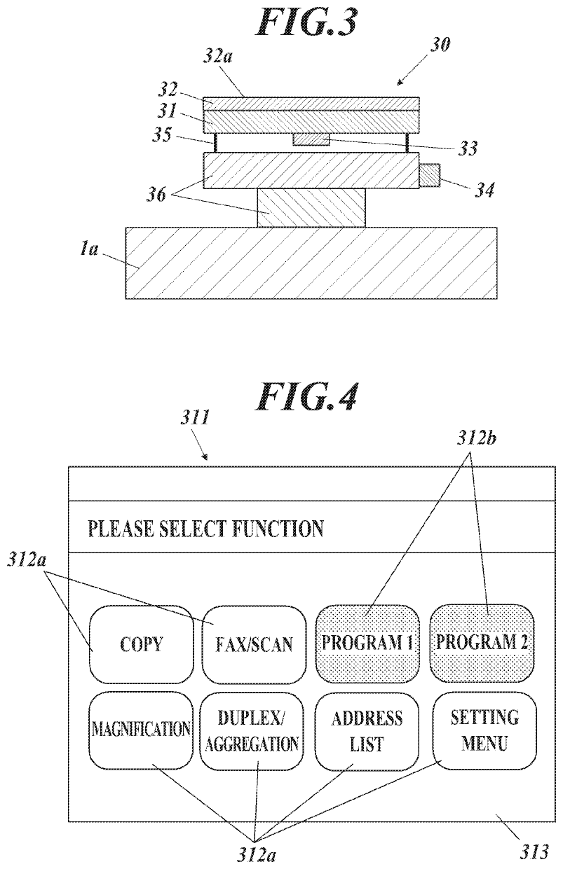

FIG. 3 is a cross-sectional view showing the configuration of the operation/display interface 30.

The operation/display interface 30 includes a display 31, a touch panel 32, a vibrator 33, a sound output unit 34, a vibration absorption member 35, and a fixing member 36.

An operation screen 311 including the state of the image forming device 1 and operation buttons 312a, 312b (operation target signs) that are targets of touch operation on the touch panel 32 is displayed on the display 31 that includes a display panel of a liquid crystal display (LCD) or the like, under the control of the controller 10.

FIG. 4 shows an example of the operation screen 311 displayed on the display 31.

The operation screen 311 is displayed in the display area 313 on the display 31. The operation buttons 312a and the operation buttons 312b (hereinafter both referred to as the operation buttons 312) respectively corresponding to various functions of the image forming device 1 are displayed on the operation screen 311.

The operation buttons 312a are active (selectable) buttons, and the operation buttons 312b are inactive (unselectable) buttons. When one of the operation buttons 312a is selected by an input operation, a function corresponding to the concerning operation button 312a is executed. When one of the operation buttons 312b is selected by an input operation, no function is executed.

The touch panel 32 shown in FIG. 3 is formed integrally with the display 31 by being overlaid thereon, and includes the operation surface 32a overlapping with the display area 313 of the display 31. The touch panel 32 detects approach/touch of an operating means (i.e., a pointer) such as a user's finger and a stylus (hereinafter, a finger is used as an example) to/on the operation surface 32a. The touch panel 32 is of the capacitance type in one or more embodiments.

FIG. 5 is a cross-sectional view showing the configuration of the touch panel 32.

The touch panel 32 includes a glass base board 321, an electrode pattern layer 322 overlaid on the glass base board 321, and a protective layer 323 covering the electrode pattern layer 322, on the display 31. The surface of the protective cover 323 forms the operation surface 32a.

The electrode pattern layer 322 includes a first layer with multiple sets of a first electrode wiring extending in a first direction, a second layer with multiple sets of a second electrode wiring extending in a second direction, and an insulating layer between the first layer and the second layer. For example, in the first electrode wiring, multiple rectangle transparent electrodes are joined in the first direction, and in the second electrode wiring, multiple rectangle transparent electrodes are joined in the second direction.

When a finger approaches the surface of the operation surface 32a, capacitive coupling is formed between the finger and part of the electrodes, and an electric field E is generated. The electrostatic capacitance between the electrodes changes according to the magnitude of the electric field E. As the ratio of the electricity flowing in parts of the first electrode wiring and the second electrode wiring according to change of the electrostatic capacitance is measured, the position (coordinates in the display area 313) selected by the finger on the operation surface 32a can be specified.

Here, the capacitive coupling between the finger and the electrodes is formed not only when the finger is touching the operation surface 32a but also when the finger is approaching the operation surface 32a (not yet in contact). This makes it possible for the touch panel 32 to detect approach of the finger to the operation surface 32a.

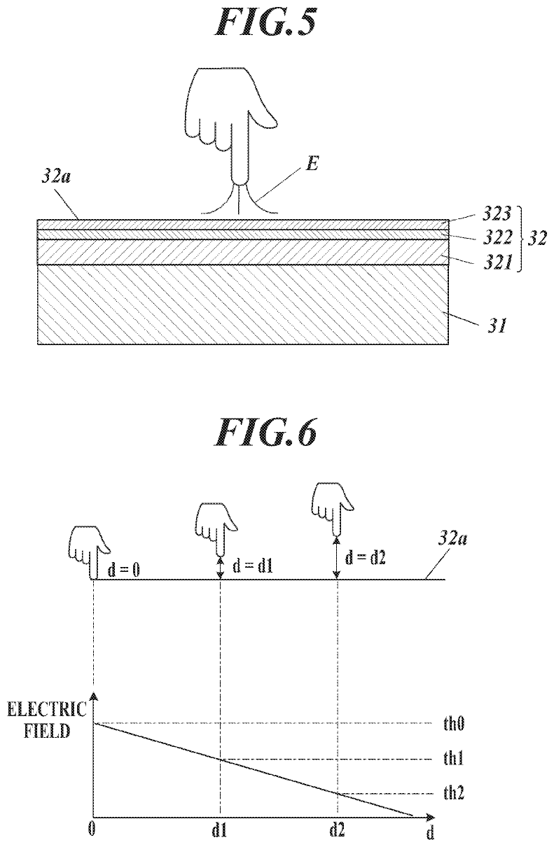

FIG. 6 is an explanatory diagram showing a method of detecting approach of a finger by the touch panel 32.

The upper part of FIG. 6 shows three different distances d between the finger and the operation surface 32a. In the state shown on the left, the finger is touching the operation surface 32a, which makes d=0. In the state shown in the middle, the finger is separated from the operation surface 32a by a distance d1, which makes d=d1. In the state shown on the right, the finger is separated from the operation surface 32a by a distance d2 (>d1), which makes d=d2.

The lower part of FIG. 6 shows a graph of relations between the distance d and the magnitude of the electric field E generated between the finger and the electrodes. As shown in this graph, the electric field E is the strongest when the finger is touching the operation surface 32a and gets weaker as the distance d between the finger and the operation surface 32a is longer.

As the threshold value th of the electric field E to be detected (actually, change in the current corresponding to the electric field E) is adjusted, approach of the finger to the operation surface 32a within the range of a predetermined detection distance dn can be detected. For example, when the threshold th of the electric field E to be detected is a threshold th1 in FIG. 6, approach of the finger to the operation surface 32a within the detection distance dn=d1 can be detected. For example, when the threshold th of the electric field E to be detected is a threshold th2 in FIG. 6, approach of the finger to the operation surface 32a within the detection distance dn=d2 can be detected.

However, as the detection distance dn is longer, the accuracy of detection of the position selected by an input operation is deteriorated. Thus, the detection distance dn may be within a predetermined upper limit value (ex. several centimeters).

In FIG. 3, the vibrator 33 is attached to the back surface of the display 31, and has vibration elements that convert electric signals into physical vibration. The vibrator 33 performs a vibration action to cause the operation surface 32a to vibrate. That is, as the vibration action to cause the vibration element to vibrate, vibration is transmitted to the operation surface 32a via the display 31 and the touch panel 32. If the finger is in contact with the operation surface 32a when vibration is transmitted to the operation surface 32a, the user senses the vibration as a response from the operation display 30 (vibration response).

Since many vibration elements vibrate in one direction, the vibrator 33 may include three vibration elements vibrating on three axes, the X axis and the Y axis on the two dimensional plane (XY plane) and the Z axis perpendicular to the X and Y axes on the display panel of the display 31.

The position and the vibration mode of the vibrator 33 are not limited to the examples described above. For example, the vibrator 33 may be attached to both ends of the display 31.

The sound output unit 34, which includes an amplifier and a speaker, outputs operation tones such as a buzzer under the control of the controller 10.

The vibration absorption member 35, which is disposed between the back surface of the display 31 and the fixing unit 36, suppresses transmission of vibration of the display 31 to the fixing unit 36 depending on the vibration action of the vibrator 33.

The fixing unit 36 is attached to the display 31 with the intermediary of the vibration absorption member 35, and is fixed to the housing 1a.

The operation/display interface 30 configured as such receives a touch operation on the touch panel 32 by the user as an input operation, and converts the input operation into an operation signal to output it to the controller 10. The operation/display interface 30 sends a notification by vibration using the vibrator 33 (vibration response) and an operation tone using the sound output unit 34 (operation tone response) to the user.

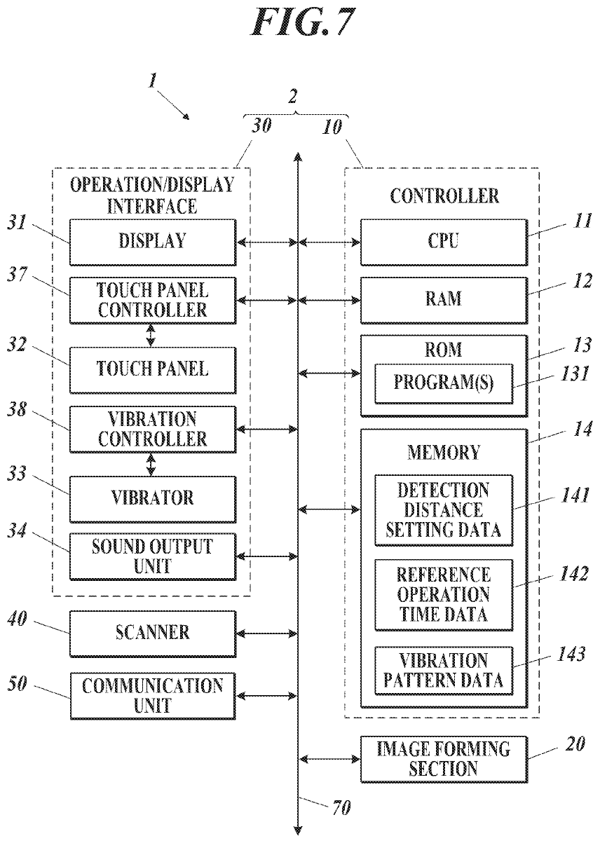

The scanner 40 includes an automatic document conveyor, an image reader, a mount tray, and a stage glass. The automatic document conveyor includes the mount tray on which document sheets are placed, a mechanism and conveying rollers to convey document sheets, and conveys the document sheets on a predetermined conveyance path. The image reader, which includes an optical system such as a light source and a reflecting mirror and an imaging element, reads the image of a document sheet conveyed on the predetermined conveyance path or placed on the platen glass, and generates image data in the bitmap format of colors of red (R), green (G), and blue (B). The scanner 40 reads an image of a document sheet and generates image data under control of the controller 10 to be stored in the memory 14 (see FIG. 7).

FIG. 7 is a block diagram showing a main configuration of the image forming device 1.

The image forming device 1 includes a controller 10 (hardware processor), an image forming section 20, the operation/display interface 30 including the display 31, the touch panel 32, a touch panel controller 37 (input operation detector) (hardware processor), the vibrator 33, a vibration controller 38 (hardware processor), and the sound output unit 34, the scanner 40, a communication unit 50, and a bus 70. The controller 10 and the operation/display interface 30 forms an input device 2 (see FIG. 7). Here, the hardware processor includes multiple circuit elements (ex. IC), but not limited thereto. Alternatively, the hardware processor may be formed of a single circuit element. Hereinafter, description of the configurations described hereinbefore is not repeated.

The touch panel controller 37 controls operations of the touch panel 32 under the control of the controller 10. The touch panel controller 37 detects approach and touch as an input operation based on detection signals from the touch panel 32 indicating approach within the detection distance dn to the operation surface 32a and touch on the operation surface 32a of the finger.

Specifically, the touch panel controller 37 refers to the setting concerning the detection distance dn stored in detection distance setting data 141 of the memory 14 and detects the input operation based on the concerning detection distance dn.

Here, the detection distance dn can be 0 or longer. The touch panel controller 37 detects approach within the detection distance dn and subsequent touch of the finger as an input operation if the detection distance dn is longer than 0 in the detection distance setting data 141, and detects touch of the finger on the operation surface 32a as an input operation if the detection distance dn is 0 in the detection distance setting data 141.

In the detection distance setting data 141 in one or more embodiments, the threshold values described above corresponding to the detection distances dn are set. The touch panel controller 37 detects an input operation when a detection signal corresponding to the electric field E equal to or greater than the threshold value th is received from the touch panel 32.

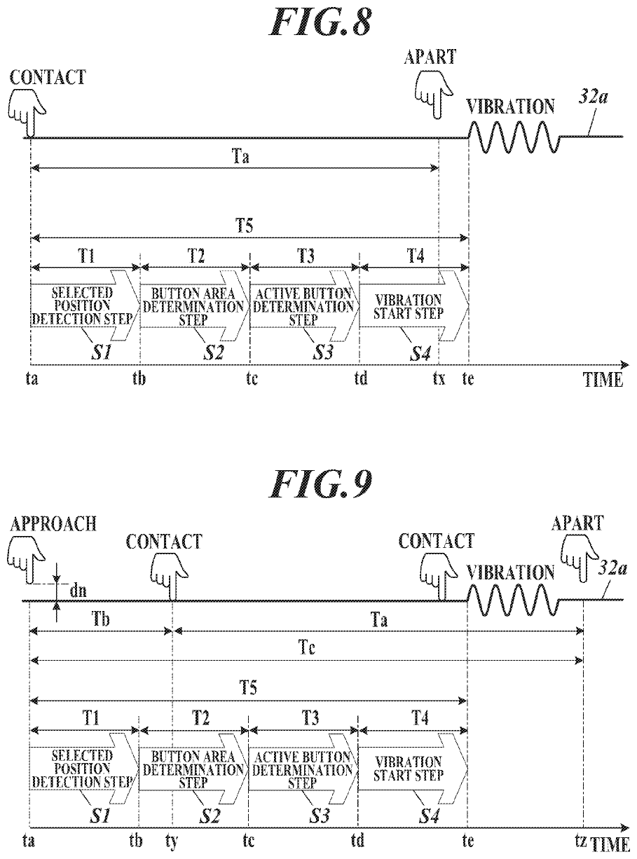

The touch panel controller 37 performs a “selected position detection step S1” (see FIG. 8) to detect the position selected by the input operation on the operation surface 32a based on the detection signal received from the touch panel 32. That is, the touch panel controller 37 specifies the selected position by detecting coordinates which the finger is approaching or coordinates which the finger touches in the display area 313, based on information on the ratio of the electricity of each set of the electrode wiring received from the touch panel 32. The touch panel controller 37 sends the data on the specified selected position to the controller 10.

The vibration controller 38 controls vibration action of the vibrator 33 based on the control signal from the controller 10. Specifically, the vibration controller 38 refers to vibration pattern data 143 stored in the memory 14 upon receipt of the control signal of start of vibration from the controller 10, and causes the vibrator 33 to vibrate in a vibration pattern designated to the received control signal. Hereinafter, the step to cause the vibrator 33 to start the vibration action is referred to as a “vibration start step S4” (see FIG. 8).

The controller 10 includes a CPU 11 (central processing unit), a RAM 12 (random access memory), a ROM 13 (read only memory), and a memory 14.

The CPU 11 reads out and executes program(s) (instruction(s)) 131 stored in the ROM 13 to perform various kinds of arithmetic processing.

The RAM 12 provides a working memory space for the CPU 11 and stores temporal data.

Various programs 131 executed by the CPU 11, setting data, etc. are stored in the ROM 13. Instead of the ROM 13, a rewritable nonvolatile memory such as EEPROM (Electrically Erasable Programmable Read Only Memory) and a flash memory can be used.

The programs 131 may be stored in the memory 14, alternatively.

The memory 14 is made of a DRAM (dynamic random access memory), etc., and image data obtained by the scanner 40, image data input externally via the communication unit 50, the detection distance setting data 141, reference operation time data 142, and the vibration pattern data 143 are stored therein.

Information concerning the setting of the detection distances do in detection of approach of the finger by the touch panel 32 is stored in the detection distance setting data 141. The detection distance setting data 141 may be stored in the RAM 12, alternatively.

The reference operation time of an input operation detected at the detection distance dn is stored for different detection distances dn in the reference operation time data 142. The reference operation time is described later.

The pattern data 143 indicates vibration patterns of the vibration action by the vibrator 33.

The vibration patterns corresponding to the operation buttons 312 on which a touch action is done on the touch panel 32 is stored in the vibration pattern data 143. Alternatively, the vibration pattern 143 may be stored in the ROM 13.

The controller 10 including the CPU 11, the RAM 12, the ROM 13, and the memory 14 described above generally controls the components of the image forming device 1 according to the programs 131.

For example, the controller 10 forms an image on a sheet by operating the components of the image forming section 20 based on the image data stored in the memory 14.

The controller 10 performs the “button area determination step S2” (see FIG. 8) to determine whether the position selected by an input operation is in the area of any of the operation buttons 312, based on the data indicating the selected position received from the touch panel controller 37.

If it is determined that the selected position is in the area of the operation buttons 312, the controller 10 performs the “active button determination step S3” (see FIG. 8) to determine whether the concerning operation button 312 is one of the active operation buttons 312a.

If it is determined that the selected position is in the area of the active operation buttons 312a, the controller 10 sends a control signal to command vibration start to the vibration controller 38. If it is determined that the selected position is not in the area of any of the operation buttons 312 or that the selected position is in the area of one of the inactive operation buttons 312b, the controller 10 does not send a control signal to command vibration start to the vibration controller 38 (that is, the vibrator 33 not to be in operation).

The controller 10 adjusts the detection distance dn by rewriting the threshold value th stored in the detection distance setting data 141. The method of adjusting the detection distance dn is described later.

The communication unit 50 is composed of a network card, etc. The communication unit 50 is connected to a communication network such as a local area network (LAN), and sends and receives to and from an external device(s) on the communication network. The controller 10 communicates with the external device(s) via the communication unit 50.

Next, the actions of acceptance of input operations by the input device 2 of the image forming device 1 and a vibration response are described.

As described above, in the input device 2, when an input operation on the active operation button 312a is detected (accepted), an operation tone response is effectuated by the sound output unit 34 and a vibration response by the vibrator 33.

It is possible to notify the user of acceptance of an input operation only by an operation tone response, but sometimes it is difficult to hear the operation tone due to the ambient noise or the like. The notifications are more certain with a vibration response being effectuated in parallel.

Here, the image forming device 1 is stationary, and can transmit vibration to the user via the finger in contact with the operation surface 32a. Thus, it is necessary that the operation surface 32a vibrates while the finger is touching the operation surface 32a.

However, vibration cannot start while the finger is touching the operation surface 32a in some cases, depending on the length of time from detection of an input operation until vibration of the operation surface 32a (hereinafter referred to as a vibration response time T5).

FIG. 8 is an explanatory diagram showing actions of a vibration response and vibration response time T5.

As shown in FIG. 8, when an input operation (here, touch of the finger) is detected at a timing ta, the selected position detection step S1, the button area determination step S2, the active button determination step S3, and the vibration start step S4 are serially performed in this order (hereinafter, these steps are also referred to as Steps S1 to S4). That is, the selected position detection step S1 is performed from the timing ta until a timing tb. The button area determination step S2 is performed until the timing tb until a timing tc. The active button determination step S3 is performed from the timing tc until a timing td. The vibration start step S4 is performed from the timing td until a timing te. Vibration of the operation surface 32a starts at the timing when the vibration start step S4 is ended. Steps S1 to S4 respectively correspond to times T1 to T4, and the vibration response time T5 is the sum of the times T1 to T4. The times T1 to T4, and the vibration response time T5 are determined depending on the processing capacity of the controller 10, and may be longer when other processing is in operation.

Here, if a timing tx when the finger gets off the operation surface 32a is earlier than a timing to when vibration starts, the user cannot sense the vibration, and the vibration response is not transmitted to the user.

In the image forming device 1 in one or more embodiments, whether the vibration response is transmitted to the user is determined by comparing a predetermined reference operation time concerning the duration of the input operation to the vibration response time T5. Here, the reference operation time is predetermined as a typical value of time from detection of an input operation until the finger gets off the operation surface 32a. The typical value is not limited, but may be the average value or the minimum value in regular operations. The time from touch on the operation surface 32a by the user's finger until the user gets off the finger is usually about 100 msec, and may be about 50 msec if the operation is quick in the range of the regular operations. Thus, the reference operation time may be 100 msec as the average value, and may be 50 msec as the minimum value. If the reference operation time is the minimum value, the vibration response can be transmitted to the user more reliably. In FIG. 8, a time Ta from the timing to until the timing tx corresponds to the reference operation time (hereinafter referred to as the reference operation time Ta).

The reference operation time Ta shown in FIG. 8 concerns the input operation (specifically, the input operation detected by contact of the finger) in a case where the detection distance dn is 0. The reference operation time concerning the input operation (specifically, the input operation detected by contact of the finger) in a case where the detection distance dn is longer than 0 gets longer as the timing of detection of the input operation is earlier. The reference operation times corresponding to different detection distances dn are stored in the reference operation time data 142. The controller 10 can acquire the reference operation time corresponding to the detection distance dn set at that point by referring to the reference operation time data 142. Alternatively, parameters to calculate the reference operation time according to the detection distance dn may be stored in the reference operation time data 142 so that the controller 10 calculates the reference operation time according to the detection distance dn.

As shown in FIG. 8, if the vibration response time T5 is equal to or longer than the reference operation time Ta, the user cannot confirm whether the input operation is accepted by the vibration response in some cases. Otherwise, the user need to continue the touch action on the operation button 312 (long-press) until vibration starts, which deteriorates the operability.

In the image forming device 1 and the input device 2, if the vibration response time T5 is equal to or longer than the reference operation time, the detection distance dn for detecting the input operation is adjusted for increase.

For example, in FIG. 8, the vibration response time T5 is longer than the reference operation time Ta concerning the input operation when the detection distance dn=0, the detection distance dn is adjusted to a value higher than 0. With this adjustment, in the action of acceptance of a subsequent input operation, the input operation is detected before the finger touches the operation surface 32a, that is, when the finger is approaching the operation surface 32a. The selected position detection step Si is then started.

FIG. 9 is an explanatory diagram showing the actions of the vibration response after adjustment of the detection distance dn.

As shown in FIG. 9, the input operation is detected at the timing ta when the finger approaches the operation surface 32a within the range of a predetermined detection distance dn (>0), and the selected position detection step S1 is started. In FIG. 9, the finger touches the operation surface 32a at a timing ty during execution of the following button area determination step S2. Compared to FIG. 8, the timings to start Steps S1 to S4 are advanced by a time Tb from the timing ta until the timing ty. Thus, the time from the timing ty when the finger touches the operation surface 32a until the timing to when the vibration start step S4 is ended is advanced by the time Tb compared to FIG. 8. As a result, the vibration start step S4 is ended before the timing tz when the finger gets off the operation surface 32a, and the operation surface 32a starts to vibrate. Thus, the user can sense the vibration response even in a case where the vibration response time T5 is longer than the reference operation time Ta in FIG. 8.

Adjustment of the detection distance dn (=0) in FIG. 8 to the detection distance dn (>0) in FIG. 9 is performed such that the reference operation time (the reference operation time Tc in FIG. 9) concerning the input operation detected based on the adjusted detection distance dn is longer than the vibration response time T5. In other words, the adjusted detection distance dn is determined such that the reference operation time is longer by a value higher than a difference between the reference operation time Ta before adjustment of the detection distance dn and the vibration response time T5.

In one or more embodiments, when the first input operation is detected after activation of the image forming device 1 (accordingly, the input device 2), the detection distance adjustment process to adjust the detection distance dn is executed. The second and subsequent input operations after activation are detected based on the detected distance dn adjusted according to the first input operation.

Here, “activation” of the image forming device 1 (input device 2) is turning on the power from off or returning to the regular operation mode from the predetermined power saver mode (standby mode).

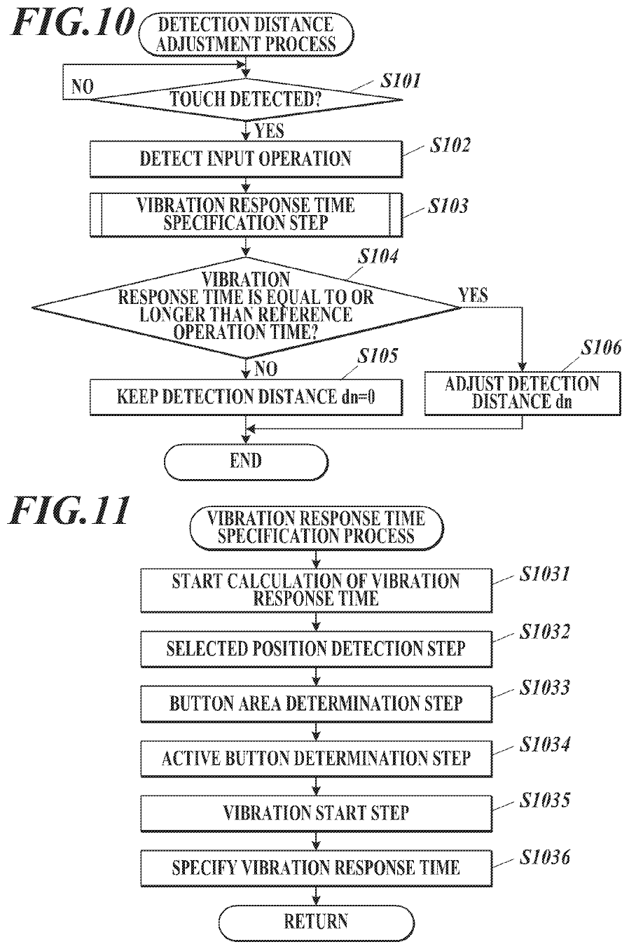

FIG. 10 is a flow chart showing control steps of a detection distance adjustment process.

The detection distance adjustment process is performed when the image forming device 1 is activated. When the image forming device 1 is activated, the detection distance dn is set to 0. That is, the threshold value th of the electric field detection in the detection distance setting data 141 is set to the threshold th, 0 in FIG. 6.

When the detection distance adjustment process is started, the touch panel controller 37 determines whether a detection signal indicating contact of the finger on the operation surface 32a from the touch panel 32 is received (Step S101). If it is determined that the detection signal is not received (Step S101: “NO”), the touch panel controller 37 executes again Step S101.

If it is determined that the detection signal indicating contact of the finger on the operation surface 32a is received (Step S101: “YES”), the touch panel controller 37 detects the touch of the finger as an input operation (here, the first input operation after activation) (Step S102: the input operation detection).

The vibration operation time specification process is executed after Step S102 (Step S103).

FIG. 11 is a flow chart showing control steps of a vibration response time specification process.

When the vibration response time specification process is requested, the controller 10 starts calculation of the vibration response time T5 (Step S1031).

The touch panel controller 37 executes the selected position detection step S1 and sends data indicating the detected selected position to the controller 10 (Step S1032).

Upon receipt of the data indicating the selected position, the controller 10 executes the button area determination step S2 (Step S1033). When the button area determination step S2 is ended, the controller 10 executes the active button determination step S3, and the sends a control signal indicating vibration start to the vibration controller 38 (Step S1034).

Upon receipt of the control signal, the vibration controller 38 executes the vibration start Step S4 (Step S1035: the vibration control). The controller 10 ends measurement of the vibration response time T5 and specifies the vibration response time T5 at the timing when Step S1035 is ended and vibration of the operation surface 32a starts (Step S1036: the vibration response time specification). When Step S1036 is ended, the controller 10 returns to the detection distance adjustment process.

In FIG. 10, the controller 10 determines whether the specified vibration response time T5 is equal to or longer than the reference operation time (Step S104). Specifically, the controller 10 refers to the reference operation time data 142, acquires the reference operation time corresponding to the detection distance dn set at that point (reference operation time Ta when dn=0), and compares the reference operation time to the vibration response time T5.

If it is determined that the vibration response time T5 is shorter than the reference operation time Ta (Step S104: “NO”), the controller 10 keeps the detection distance dn at 0 (Step S105). That is, the controller 10 keeps the threshold value th of electric field detection in the detection distance setting data 141 at th=0 in FIG. 6.

If it is determined that the vibration response time T5 is equal to or longer than the reference operation time Ta (Step S104: “YES”), the controller 10 adjusts the detection distance dn in the range longer than 0 (Step S106: the detection distance adjustment). Here, the controller 10 adjusts the threshold th of electric field detection in the detection distance setting data 141 to a value lower than the threshold value th, 0, in FIG. 6. Specifically, the controller 10 adjusts the detection distance dn such that the reference operation time (the reference operation time Tc in FIG. 9) corresponding to the adjusted detection distance dn is longer than the vibration response time T5. That is, the controller 10 sets the threshold value th corresponding to the concerning detection distance dn (for example, a threshold value th1 in FIG. 6 if the detection distance dn is a distance d1), and the concerning setting is stored in the detection distance setting data 141.

When Steps S105 and S106 are ended, the controller 10 ends the detection distance adjustment process.

In the case where detection of touch of the finger is accepted as the input operation at Step S101, a step for realizing a function corresponding to the accepted input operation (for example, image formation) may be executed.

However, in a case where the detection distance adjustment process is executed in the predetermined setting of the image forming device 1, detection of touch of the finger at Step S101 may be used only for setting of the detection distance, and the step for realizing a function may not be executed.

Next described is the input operation acceptance process concerning acceptance of input operations after adjustment of the detection distance dn (that is, the second and subsequent input operations).

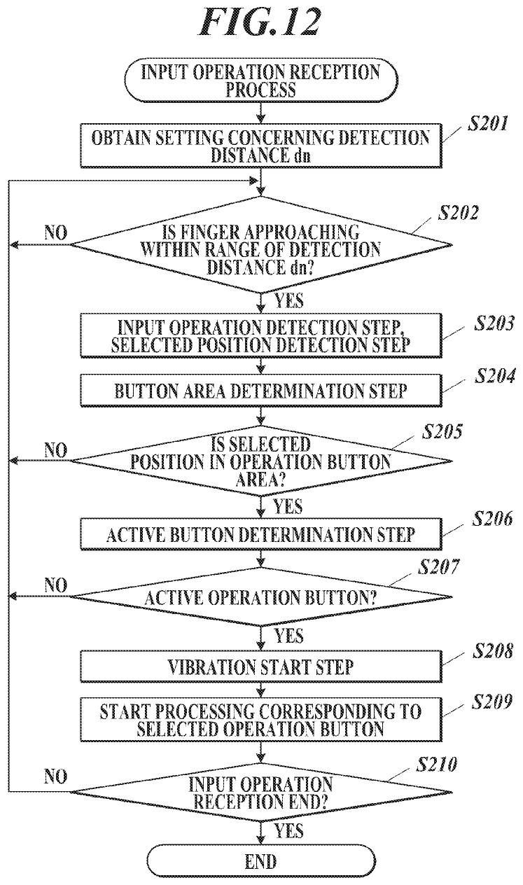

FIG. 12 is a flow chart showing control steps of the input operation acceptance process. When the input operation acceptance process is started, the touch panel controller 37 acquires the setting concerning the detection distance dn stored in the detection distance setting data 141 (Step S201), and determines whether the finger approaches the operation surface 32a within the detection distance dn from the operation surface 32a (whether the finger touches the operation surface 32a, if the detection distance dn=0) (Step S202). Here, if a detection signal indicating that an electric field equal to or greater than a threshold value th corresponding to the detection distance dn is generated is received from the touch panel 32, the touch panel controller 37 determines that the finger approaches within the detection distance dn. If it is determined that the finger is not approaching within the detection distance dn (Step S202: “NO”), the touch panel controller 37 executes again Step S202.

If it is determined that the finger approaches within the range of the detection distance do (Step S202: “YES”), the touch panel controller 37 detects approach of the finger as an input operation, and executes the selected position detection step S1 to specify the selected position (Step S203). The touch panel controller 37 sends data on the selected position to the controller 10.

The controller 10 executes the button area determination step S2 (Step S204), determines whether the selected position is in the area of any of the operation buttons 312 (Step S205). If it is determined that the selected position is not in the area of any of the operation buttons 312 (Step S205: “NO”), the controller 10 returns the process to Step S202.

If it is determined that the selected position is in the area of any of the operation buttons 312 (Step S205: “YES”), the controller 10 executes the active button determination step S3 (Step S206), and determines whether the selected button 312 is one of the active operation buttons 312a (Step S207). If it is determined that the selected operation button 312 is one of the inactive operation buttons 312b (Step S207: “NO”), the controller 10 returns the process to Step S202. If it is determined that the selected operation button 312 is one of the active operation buttons 312a (Step S207: “YES”), the controller 10 sends a control signal indicating vibration start to the vibration controller 38. Upon receipt of the concerning control signal, the vibration controller 38 executes the vibration start step S4 (Step S208). The vibration response is done thereby.

The controller 10 starts a step for realizing a function corresponding to the selected operation button 312 (for example, image formation) (Step S209). The controller 10 determines whether acceptance of the input operation is to be ended (Step S210). If acceptance of the input operation is continued (Step S210: “NO”), the controller 10 returns the process to Step S202. If the acceptance of the input operation is ended (Step S210: “YES”), the controller 10 ends the input operation acceptance process.

Next, variations of the above-described embodiments are described. The following variations may be combined with each other.

### (Variation 1)

In the above-described embodiments, the detection distance dn is adjusted according to the first input operation after activation of the image forming device 1. In Variation 1, the detection distance dn is concurrently adjusted every time an input operation is detected. Specifically, the vibration response time T5 is measured every time an input operation is detected, and the detection distance dn is adjusted each time the vibration response time T5 is equal to or longer than the reference operation time. Hereinafter, the differences from the above-described embodiments are described.

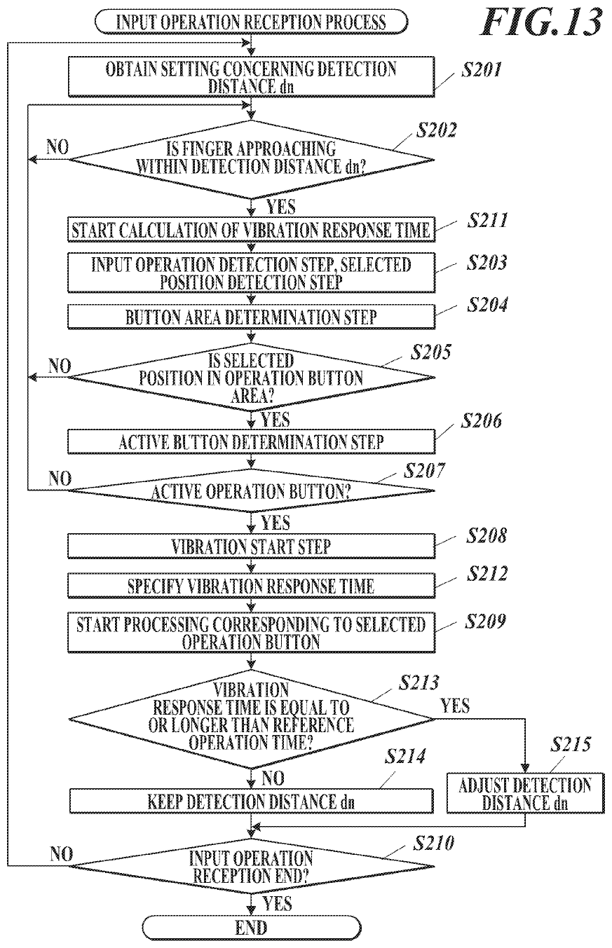

FIG. 13 is a flow chart showing control steps of an input operation reception process in Variation 1.

In the flow chart in FIG. 13, Step S211 is added after Step S202 in the flow chart in FIG. 12, Step S212 after Step S208, and Steps S213 to S215 after Step S209, and the branch target after “NO” at Step S210 is changed to Step S201. The differences from the flow chart in FIG. 12 are described below.

In the input operation acceptance process in this Variation, if it is determined that the finger approaches within the range of the detection distance dn at Step S202 (Step S202: “YES”), the controller 10 starts measurement of the vibration response time T5 (Step S211).

When the vibration start process of Step S208 is executed to start vibration of the operation surface 32a, the controller 10 ends measurement of the vibration response time T5 and specifies the vibration response time T5 (Step 212: the vibration response time specification).

After Step S209, the controller 10 determines whether the specified vibration response time T5 is equal to or longer than the reference operation time (Step S213). The reference operation time used here is the reference operation time corresponding to the detection distance set at that point. For example, in the case where the detection distance dn shown in FIG. 9 is set at that point, the reference operation time Tc in FIG. 9 is used.

If it is determined that the vibration response time T5 is shorter than the reference operation time (Step S213: “NO”), the controller 10 keeps the detection distance dn (Step S214). If it is determined that the vibration response time T5 is equal to or longer than the reference operation time (Step S213: “YES”), the controller 11 adjusts the detection distance dn for increase (Step S215: the detection distance adjustment).

If it is determined that acceptance of the input operation is continued at Step S210 after Step S214 or Step S215 (Step S210: “NO”), the controller 10 shifts the process to Step S201, acquires the setting concerning the latest detection distance dn, and executes Step S202 and the subsequent steps based on the setting.

### (Variation 2)

Next, Variation 2 of the above-described embodiments is described.

In the above-described embodiments, the detection distance dn is adjusted for increase if the vibration response time T5 is equal to or longer than the reference operation time, but in Variation 2, the adjustment range is given an upper limit.

For example, as the operation buttons 312 are smaller, the selected position of the input operation need to be more accurately detected. Thus, the detection distance dn is adjusted in the range equal to or less than the first upper limit that is set to a lower value for the operation buttons 312 smaller in size. Here, the size of the operation buttons 312 may be the area or the maximum width of the operation buttons 312.

Alternatively, the detection distance may be adjusted in the range equal to or less than the second upper limit that is set to a lower value for detection of the selected position with a lower accuracy depending on the characteristics of the touch panel 32.

### (Variation 3)

Next, Variation 3 of the above-described embodiments is described.

In the above-described embodiments, the touch panel 32 of the capacitance type is used, though not limited thereto. A touch panel of other types such as an optical type and electromagnetic induction type may be used.

A touch panel that can detect input operations by multiple different methods may be used. In Variation 3, the touch panel that can detect input operations by the capacitance method and the optical method is described as an example.

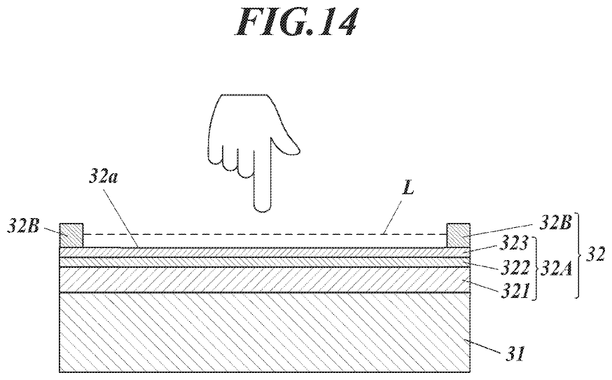

FIG. 14 is a cross-sectional view showing a configuration of the touch panel 32 in Variation 3.

The touch panel 32 shown in FIG. 14 includes a glass base board 321, a capacitance type detector 32A including an electrode pattern layer 322 and a protection cover 323, an optical detector 32B formed on the operation surface 32a. The configuration of the capacitance type detector 32A is similar to that of the touch panel 32 shown in FIG. 5.

The optical detector 32B includes a light emitting unit that emits light L in an optical path parallel to the operation surface 32a and a light receiving unit that receives and detects the light L.

The height of the optical path of the light L is set to a predetermined detection distance from the operation surface 32a. The optical detector 32B as such can detect approach to the operation surface 32a within the detection distance and a position on the operation surface 32a of a finger based on a position where the light L is blocked by the finger and the light is no longer detected by the light L.

The capacitance type detector 32A and the optical detector 32B detect approach of the finger within the different detection distances from the operation surface 32a. This makes it possible to detect input operations at the predetermined detection distance dn based on the detection result from one of the capacitance type detector 32A and the optical detector 32B depending on the detection distance dn set in the detection distance setting data 141. In other words, the touch panel controller 37 detects the input operations at the predetermined detection distance dn by switching the detector to be used between the capacitance type detector 32A and the optical detector 32B depending on the set detection distance dn.

### (Variation 4)

Next, Variation 4 of the above-described embodiments is described.

In the above-described embodiments, the reference operation time is determined beforehand for the different detection distances dn, but in this variation, the reference operation time is set based on the actual duration of the input operation.

Specifically, when the touch panel controller 37 detects an input operation, the controller 10 specifies the duration of the input operation (from when the input operation is detected until the finger gets off the operation surface 32a) and uses the duration as the reference operation time. If it is determined that the vibration response time T5 is equal to or longer than this duration (the reference operation time), the controller 10 adjusts the detection distance dn.

The results of adjustment of the detection distances dn may be stored in the memory 14 associated to multiple users. Specifically, the detection distance information in which the detection distance dn is associated to each of multiple users may be included in the detection distance setting data 141. In that case, user authentication (login) by a predetermined authentication process is performed to specify the user who is operating the image forming device 1, and an input operation is detected based on the detection distance dn associated to the specified user in the detection distance information. This makes it possible to set an appropriate detection distance dn depending on the specific duration of the input operation of each user and vibration responses can be more reliable.

As described above, the input device 2 according to the embodiments includes the display 31; the touch panel 32 including the operation surface 32a that overlaps the display area 313 of the display 31; the vibrator 33 that performs the vibration action to cause the operation surface 32a to vibrate; and the controller 10 (hardware processor), wherein the controller 10: detects, as an input operation, approach of an operating means (finger) within a detection distance dn to the operation surface 32a and touch of the operating means on the operation surface 32a; causes the vibrator 33 to perform the vibration action according to the input operation detected by the controller 10; and adjusts the detection distance dn so that the vibrator 33 starts the vibration action before the input operation ends.

This makes it possible to start vibration of the operation surface 32a while the user's finger is touching the operation surface 32a by advancing the timings to start Steps S1 to S4 concerning the vibration response even in a case where it takes time before start of the vibration response because of low processing capacity of the controller 10 or other processing in operation in parallel. Thus, the vibration responses can be more reliable.

The controller 10: specifies a position on the operation surface 32a selected by the input operation; and causes the vibrator 33 to perform the vibration action according to the selected position. This makes it possible for the user to recognize that the desired position is selected by the vibration response.

The operation button 312 is displayed in the display area 313 on the display 31, and wherein the controller 10: determines whether the selected position is in an area of the operation button 312; and in response to the selected position being in the area of the operation button 312, causes the vibrator 33 to perform the vibration action. This makes it possible to appropriately effectuate the vibration response according to the result of determination of whether the selected position is in the area of the operation buttons 312. The vibration response time T5 is likely to be longer with the button area determination step S2. But the vibration responses can be more reliable as the timings to start Steps S1 to S4 concerning the vibration responses can be adjusted by adjustment of the detection distance dn.

The controller 10 according to Variation 2 adjusts the detection distance dn in a range equal to or less than the first maximum value that is set lower as the operation button 312 is smaller. This makes vibration responses more reliable while suppressing misdetection of selection of the operation buttons 312.

The controller 10: in response to the selected position being in the area of the operation button 312, determines whether the operation button 312 is active; and in response to the operation button 312 being an active button 312a, causes the vibrator 33 to perform the vibration action. This makes it possible to appropriately effectuate the vibration response according to the result of determination of whether the active operation button 312a is selected. The vibration response time T5 is likely to be longer with the active button determination step S3. But the vibration response can be more reliable as the timings to start Steps S1 to S4 concerning the vibration response can be adjusted by adjustment of the detection distance dn.

The controller 10 according to Variation 2 adjusts the detection distance dn in a range equal to or less than the second maximum value that is set lower as an accuracy of detection of the selected position depending on a characteristic of the touch panel 32 is lower. This makes vibration responses more reliable while suppressing misdetection of the positions of the input operations.

The controller 10: specifies a vibration response time T5 from detection of the input operation until start of the vibration action; and in response to the vibration response time T5 being equal to or longer than a reference operation time concerning a duration of the input operation, adjusts the detection distance dn so that the reference operation time based on the adjusted detection distance dn is longer than the vibration response time T5. This makes it possible to start vibration of the operation surface 32a while the user's finger is touching the operation surface 32a by advancing the timings to start Steps S1 to S4 concerning the vibration response even in the case where the vibration response time T5 is longer than the reference operation time because of low processing capacity of the controller 10 or other processing in operation in parallel. Thus, the vibration responses can be more reliable.

The controller 10 according to Variation 4: in response to detection of the input operation, specifies the duration of the input operation; and in response to the vibration response time T5 being equal to or longer than the specified duration, adjusts the detection distance dn. This makes it possible to appropriately adjust the timings to start Steps S1 to S4 concerning the vibration response according to the actual duration of the input operation by the user. Thus, it is possible to suppress deterioration of the accuracy of detecting positions as the detection distance dn is longer than necessary with reliable vibration response.

The controller 10: in response to detection of the input operation that is the first input after activation of the input device 2, adjusts the detection distance dn; and detects the input operation that is the second or subsequent input after the activation, based on the adjusted detection distance dn. This makes it possible to advance the timings to start Steps S1 to S4 concerning the vibration response according to change in the operation environment at every activation. Thus, the vibration responses can be more reliable.

The controller 10 according to Variation 1 adjusts the detection distance dn every time the input operation is detected. This makes it possible to concurrently adjust the timings to start Steps S1 to S4 concerning the vibration response according to change in the operation environment at every activation. Thus, the vibration response can be more reliable even if the operation environment changes after activation.

The touch panel 32 according to Variation 3 includes a capacitance type detector 32A and an optical detector 32B that respectively detect the approach of the operating means within different detection distances dn to the operation surface, and wherein the controller 10 detects the input operation based on a detection result of one of the capacitance type detector 32A and the optical detector 32B. This makes it possible to change the detection distance dn by a simple process of switching the detector to be used.

The controller 10: stores detection distance information in the memory 14, the detection distance information including detection distances dn that are respectively associated to a plurality of users; and detects the input operation based on one of the detection distances dn that is associated to a user currently operating the input device 2 in the detection distance information. This makes it possible to appropriately adjust the timings to start Steps S1 to S4 depending on the specific duration of the input operation of each user. Thus, the vibration responses can be more reliable.

The image forming device 1 according to the embodiments includes: the input device 2 described above; and the image forming section 20 that forms an image on a recording medium based on the input operation detected by the input device 2. This makes it possible to perform the vibration response more reliably.

The control method of the input device 2 according to the embodiments includes: the input operation detection step to detect, as an input operation, approach of an operating means within a detection distance to the operation surface 32a and touch of the operating means on the operation surface 32a; the vibration control step to cause the vibrator 33 to perform the vibration action according to the input operation detected in the input operation detection step; and the detection distance adjustment step to adjust the detection distance dn so that the vibrator 33 starts the vibration action before the input operation ends. This makes it possible to start vibration of the operation surface 32a while the user's finger is touching the operation surface 32a by advancing the timings to start Steps S1 to S4 concerning the vibration response even in the case where it takes time before start of the vibration response. Thus, the vibration responses can be more reliable.

The instructions according to the embodiments causes the controller 10 as the computer of the input device 2 to: detect, as an input operation, approach of an operating means (finger) within a detection distance dn to the operation surface 32a and touch of the operating means on the operation surface 32a; cause the vibrator 33 to perform the vibration action according to the input operation detected by the controller 10; and adjust the detection distance dn so that the vibrator 33 starts the vibration action before the input operation ends. This makes it possible to start vibration of the operation surface 32a while the user's finger is touching the operation surface 32a by advancing the timings to start Steps S1 to S4 concerning the vibration response even in the case where it takes time before start of the vibration response. Thus, the vibration responses can be more reliable.

The present invention is not limited to the above embodiments and variations, and various changes can be made.

For example, the controller 10 can execute at least part of the processing to be executed by the touch panel controller 37 as the input operation detector and the vibration controller 38. In the case where the controller 10 executes all the processing to be executed by the touch panel controller 37, the touch panel controller 37 can be omitted. In the case where the controller 10 executes all the processing to be executed by the vibration controller 38, the vibration controller 38 can be omitted.

The touch panel controller 37 or the vibration controller 38 can execute at least part of the processing to be executed by the controller 10.

In the above-described embodiments, the threshold values th corresponding to the detection distances dn are stored in the detection distance setting data 141, and the detection distance dn is adjusted by modification of the threshold value th by the controller 10, though not limited thereto. The adjustment of the detection distance dn includes modification of a parameter corresponding to the detection distance dn. Such a parameter may be the above-mentioned threshold th, the ratio of the electric charge of the electric capacity of sets of the electrode wiring of the touch panel 32, or the detection distance dn. Thus, the adjustment of the detection distance dn may be modification of such parameters stored in the detection distance setting data 141 by the controller 10.

In the above-described embodiments, the detection distance dn is adjusted in the case where the vibration response time T5 is equal to or longer than the reference operation time, but a marginal time necessary for the user to sensor the vibration response may be taken into consideration. The detection distance dn may be adjusted in the case where the vibration response time T5 is equal to or longer than the reference operation time minus a predetermined marginal time. By considering the marginal time as described above, vibration can be started while the finger is touching the operation surface 32a, and can be transmitted to the finger at least for as long as needed to sense the vibration response.

In the above-described embodiments, adjustment is done for increase of the detection distance dn, though not limited thereto. Adjustment may be done for decrease of the detection distance dn in parallel. For example, in the case where the vibration response time T5 is shorter than the reference operation time by a predetermined time or more, the detection distance dn may be adjusted for increase in a range where the reference operation time after adjustment is longer than the vibration response time T5. This makes it possible to make the detection distance dn as short as possible and improve the accuracy of detection of the selected position.

The active button determination step S3 of the above-described steps S1 to S4 may be omitted, and the vibration response may be effectuated regardless of whether the operation button 312 is active. The button area determination step S2 may be omitted, and the vibration response may be effectuated even when the position selected by an input operation is outside the area of the operation buttons 312.

The image forming device is not limited to an MFP, but may be an electrophotographic single-function printer, or an inkjet recording printer.

In the above-described embodiments, the input device is applied to the image forming device, though not limited thereto. The input device of one or more embodiments of the present invention may be applied to other electronic devices (especially, stationary ones which are not to be held by hand).

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

What is claimed is:

1. An input device comprising:
a display having a display area;
a touch panel having an operation surface that overlaps the display area;
a vibrator that generates a vibration causing the operation surface to vibrate; and
a hardware processor that
detects, as an input operation, approach of a pointer within a detection distance from the operation surface and touch of the pointer on the operation surface;
causes the vibrator to generate the vibration based on the input operation; and
adjusts the detection distance and causes the vibrator to start generating the vibration before the input operation ends.

2. The input device according to claim 1, wherein
the hardware processor:
specifies a position on the operation surface selected by the input operation; and
causes the vibrator to generate the vibration based on the selected position.

3. The input device according to claim 2, wherein
a predetermined operation target sign having an area is displayed in the display area, and
the hardware processor:
determines whether the selected position is within the area of the operation target sign; and
upon determining that the selected position is within the area of the operation target sign, causes the vibrator to generate the vibration.

4. The input device according to claim 3, wherein
the hardware processor adjusts the detection distance within a range equal to or less than a first maximum value,
the first maximum value is set lower as the operation target sign is smaller.

5. The input device according to claim 3, wherein
the hardware processor:
upon determining that the selected position is within the area of the operation target sign, determines whether the operation target sign is active; and
upon determining that the operation target sign is active, causes the vibrator to generate the vibration.

6. The input device according to claim 2, wherein
the hardware processor adjusts the detection distance within a range equal to or less than a second maximum value, and
the second maximum value is set lower as an accuracy of detection of the selected position is lower, the accuracy depending on a characteristic of the touch panel.

7. The input device according to claim 1, wherein
the hardware processor:
specifies a vibration response time from detection of the input operation until start of generation of the vibration; and
when the vibration response time is equal to or longer than a reference operation time, adjusts, based on the adjusted detection distance, the detection distance to make the reference operation time longer than the vibration response time, the reference operation time relating to a duration of the input operation.

8. The input device according to claim 7, wherein
the hardware processor:
upon detecting the input operation, specifies the duration of the input operation; and
when the vibration response time is equal to or longer than the specified duration, adjusts the detection distance.

9. The input device according to claim 1, wherein
the hardware processor:
upon detecting the input operation that is a first input after activation of the input device, adjusts the detection distance; and
detects the input operation that is a second or a subsequent input after the activation, based on the adjusted detection distance.

10. The input device according to claim 1, wherein the hardware processor adjusts the detection distance every time the input operation is detected.

11. The input device according to claim 1, wherein
the touch panel comprises a plurality of detectors that respectively detect the approach of the pointer within different detection distances from the operation surface, wherein
the detectors are different from one another in a way of detecting, and
the hardware processor detects the input operation based on a detection result from one of the detectors.

12. The input device according to claim 1, wherein
the hardware processor:
stores detection distance information in a predetermined memory, the detection distance information including detection distances that include the detection distance and respectively correspond to a plurality of users; and
detects the input operation based on one of the detection distances in the detection distance information, the one of the detection distances corresponding to, among the users, a user currently operating the input device.

13. An image forming device comprising:
the input device according to claim 1; and
an image former that forms an image on a recording medium based on the input operation detected by the input device.

14. A control method of an input device comprising a display, a touch panel, and a vibrator, wherein the display has a display area, the touch panel has an operation surface that overlaps with the display area, and the vibrator generates a vibration causing the operation surface to vibrate, the method comprises:
detecting, as an input operation, approach of a pointer within a detection distance from the operation surface and touch of the pointer on the operation surface;
causing the vibrator to generate the vibration based on the input operation; and
adjusting the detection distance and causing the vibrator to start generating the vibration before the input operation ends.

15. A computer-readable recording medium storing instructions for an input device comprising a display, a touch panel, and a vibrator, wherein the display has a display area, the touch panel has an operation surface that overlaps with the display area, and the vibrator generates a vibration causing the operation surface to vibrate, the instructions causing a computer of the input device to:
detect, as an input operation, approach of a pointer within a detection distance from the operation surface and touch of the pointer on the operation surface;
cause the vibrator to generate the vibration based on the input operation; and
adjust the detection distance and cause the vibrator to start generating the vibration before the input operation ends.
